(19) United States
(12) Patent Application Publication
(10) Pub. No.: US 2026/0135652 A1
(43) Pub. Date: May 14, 2026

(54) METHOD AND DEVICE FOR RECEIVING AND TRANSMITTING INFORMATION

(71) Applicant: Samsung Electronics Co., Ltd., Suwon-si, Gyeonggi-do (KR)

(72) Inventors: Zhe CHEN, Beijing (CN); Feifei SUN, Beijing (CN); Jingxing FU, Beijing (CN); Bin YU, Beijing (CN)

(21) Appl. No.: 19/115,512

(22) PCT Filed: Sep. 27, 2023
(86) PCT No.: PCT/KR2023/015084

§ 371 Date: Mar. 26, 2025

(30) Foreign Application Priority Data
Sep. 28, 2022 (CN) 202211194384.6

(51) Int. Cl. H04L 5/00

(52) U.S. Cl. CPC H04L 5/0048

(57) ABSTRACT

The disclosure relates to a 5G or 6G communication system for supporting a higher data transmission rate. The present disclosure provides a method and device for receiving and transmitting information and/or signals, which can improve the performance of cell switch by improving the measurement, reporting and indication of reference signals.

### TECHNICAL FIELD

The present application relates to the technical field of wireless communication, and more specifically, to a method and device for receiving and transmitting information.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The transmission from a base station to a User Equipment (UE) is referred to as downlink, and the transmission from a UE to a base station is referred to as uplink.

### DISCLOSURE OF INVENTION

### Technical Problem

The 5G wireless communication system supports mobility management. This enables the terminal device to maintain high-quality communication with the network device even when it is moving. However, when the moving speed of the terminal device is further improved, it will quickly pass through multiple cells. This means that the terminal device needs frequent cell switch. Therefore, there is a need for a method capable of improving cell switch performance when the terminal device frequently performs cell switch and a device for performing the method.

### Solution to Problem

An aspect of the present disclosure provides a method performed by a terminal device UE in a wireless communication network, the method including: receiving indication information from a base station, wherein the indication information indicates information of first cell(s) associated with a reference signal; and determining a timing of the reference signal based on a timing of the first cell(s).

In an example, the information of the first cell(s) associated with the reference signal includes an identifier of the first cell(s) associated with a quasi co-location QCL reference signal of the reference signal.

In an example, the determining of the timing of the reference signal based on the timing of the first cell(s) includes one of: determining the timing of the reference signal based on the timing of the first cell(s) based on an identifier of the first cell(s) associated with a QCL reference signal of the reference signal indicated by the indication information.

In an example, the method further includes at least one of: determining the timing of the reference signal according to a timing of a serving cell based on the indication information indicating that a QCL reference signal of the reference signal does not correspond to a PCI of the first cell(s); determining the timing of the reference signal according to the timing of the first cell(s) based on the indication information indicating that the timing of the reference signal is not the timing of the serving cell; determining the timing of the reference signal according to the timing of the serving cell based on the indication information indicating that the timing of the reference signal is the timing of the serving cell.

In an example, the reference signal is used for Layer 1 measurement.

An aspect of the present disclosure provides a method performed by a terminal device UE in a wireless communication network, the method including: receiving indication information of a mobility reference signal for Layer 1 measurement and/or Layer 3 measurement from a base station; and performing the Layer 1 measurement and/or the Layer 3 measurement related to the mobility reference signal according to the indication information.

In an example, the performing of the Layer 1 measurement and/or the Layer 3 measurement related to the mobility reference signal according to the indication information includes one of: performing the Layer 1 measurement related to the mobility reference signal based on the indication information of the mobility reference signal for the Layer 1 measurement; performing the Layer 3 measurement related to the mobility reference signal based on the indication information of the mobility reference signal for the Layer 3 measurement; performing the Layer 3 measurement and the Layer 1 measurement related to the mobility reference signal based on the indication information of the mobility reference signal for the Layer 3 measurement and the Layer 1 measurement; performing the Layer 1 measurement or the Layer 3 measurement related to the mobility reference signal in a case that the indication information is not received.

In an example, the method further includes: reporting a UE capability including: a capability to support performing the Layer 1 measurement using the mobility reference signal and/or performing the Layer 3 measurement using the mobility reference signal.

An aspect of the present disclosure provides a method performed by a terminal device UE in a wireless communication network, the method including: receiving reporting configuration information from a base station; receiving indication information from a base station, wherein the indication information indicates information of first cell(s) associated with reference signal(s); reporting reference signal information and corresponding indicator(s), wherein the indicator(s) indicates mobility related information of the first cell(s).

In an example, the indicator(s) indicating the mobility related information of the first cell(s) includes: the indicator indicating whether the first cell(s) satisfies a cell switch condition.

In an example, the indicator is determined according to at least one of: a measurement result of a reference signal corresponding to the reference signal information; a measurement result of a reference signal corresponding to a serving cell; K measurement results of the reference signal corresponding to the reference signal information, where K is an integer greater than or equal to 1.

An aspect of the present disclosure provides a method performed by a terminal device UE in a wireless communication network, the method including: receiving configuration information including information related to at least one reference signal from a base station; triggering reporting according to whether a measurement result of the at least one reference signal satisfies a predetermined condition; wherein the triggering of the reporting includes at least one of: the at least one reference signal includes a first reference signal and a second reference signal, and when a measurement result of the first reference signal and a measurement result of the second reference signal satisfy the predetermined condition, triggering the reporting; the at least one reference signal includes the first reference signal, and when K measurement results of the first reference signal satisfy the predetermined condition, triggering the reporting.

In an example, the reporting is transmitted via at least one of: a media access control control element MAC-CE; a physical random access channel PRACH; a scheduling request SR; a channel state information CSI report.

An aspect of the present disclosure provides a method performed by a terminal device UE in a wireless communication network, the method including: receiving, by the UE, indication information from a base station, wherein the indication information includes transmission configuration indication TCI state indication information; and not requiring the UE to perform transmission or reception in a first time period, wherein the first time period is related to the indication information.

In an example, the first time period being related to the indication information includes one of: a start point of the first time period is based on a channel or signal carrying the indication information; the start point of the first time period is based on a channel or signal carrying a feedback corresponding to the indication information; an end point of the first time period is a slot of first cell(s); the end point of the first time period is related to reference signal transmission of the first cell(s); the end point of the first time period is related to PRACH transmission of the first cell(s); a length of the first time period is related to a subcarrier spacing SCS of a serving cell of the UE; the length of the first time period is related to an SCS of the first cell(s); wherein the indication information further includes information related to the first cell(s).

An aspect of the present disclosure provides a method performed by a terminal device UE in a wireless communication network, the method including: receiving indication information from a base station in a second cell, wherein the indication information includes transmission configuration indication TCI state indication information and information of first cell(s); and performing at least one of the following behaviors in the first cell(s) according to the indication information: applying the TCI state indication; triggering reference signal transmission; reporting channel state information CSI reporting; transmitting a physical random access channel PRACH; releasing a serving cell of the UE.

An aspect of the present disclosure provides a method performed by a terminal device UE in a wireless communication network, the method including: receiving at least one reference signal information and information related to first cell(s) corresponding to the reference signal information transmitted by a base station; transmitting a request corresponding to first reference signal information of the at least one reference signal information to the base station; receiving a response to the request from the base station; applying the first reference signal information in the first cell(s).

In an example, the applying of the configuration information in the first cell(s) comprises: applying the reference signal information after a second time period in which the response is received.

In an example, a length of the second time period is related to an SCS of a serving cell of the UE; or, a length of the second time period is related to an SCS of the first cell(s).

An aspect of the present disclosure provides a method performed by a base station in a wireless communication system, the method including: transmitting indication information, wherein the indication information indicates information of first cell(s) associated with a reference signal; and transmitting the reference signal.

In an example, the information of the first cell(s) associated with the reference signal includes an identifier of the first cell(s) associated with a quasi co-location QCL reference signal of the reference signal.

In an example, the timing of the reference signal is determined based on the timing of the first cell(s) based on an identifier of the first cell(s) associated with a QCL reference signal of the reference signal indicated by the indication information.

In an example, the timing of the reference signal is determined according to a timing of a serving cell based on the indication information indicating that a QCL reference signal of the reference signal does not correspond to a PCI of the first cell(s).

In an example, the timing of the reference signal is determined according to the timing of the first cell(s) based on the indication information indicating that the timing of the reference signal is not the timing of the serving cell.

In an example, the timing of the reference signal is determined according to the timing of the serving cell based on the indication information indicating that the timing of the reference signal is the timing of the serving cell.

In an example, the reference signal is used for Layer 1 measurement.

An aspect of the present disclosure provides a method performed by a base station in a wireless communication network, the method including: transmitting indication information of a mobility reference signal for Layer 1 measurement and/or Layer 3 measurement, wherein the indication information is used to indicate a terminal device UE to perform the Layer 1 measurement and/or the Layer 3 measurement related to the mobility reference signal; transmitting the mobility reference signal.

In an example, the transmitting of the indication information of the mobility reference signal for the Layer 1 measurement and/or the Layer 3 measurement further includes transmitting at least one of: the indication information of the mobility reference signal for the Layer 1 measurement; the indication information of the mobility reference signal for the Layer 3 measurement; the indication information of the mobility reference signal for the Layer 3 measurement and the Layer 1 measurement.

In an example, the method further includes receiving, from the UE, a UE capability including: a capability to support performing the Layer 1 measurement using the mobility reference signal and/or performing the Layer 3 measurement using the mobility reference signal.

An aspect of the present disclosure provides a method performed by a base station in a wireless communication system, the method including: transmitting reporting configuration information; transmitting indication information, wherein the indication information indicates information of first cell(s) associated with reference signal(s); and receiving reference signal information and corresponding indicator(s), wherein the indicator(s) indicates mobility related information of the first cell(s).

In an example, the indicator(s) indicating the mobility related information of the first cell(s) includes: the indicator indicating whether the first cell(s) satisfies a cell switch condition.

In an example, the indicator(s) is determined according to at least one of: a measurement result of a reference signal corresponding to the reference signal information; a measurement result of a reference signal corresponding to a serving cell; K measurement results of the reference signal corresponding to the reference signal information, where K is an integer greater than or equal to 1.

An aspect of the present disclosure provides a method performed by a base station in a wireless communication network, the method including: transmitting configuration information including information related to at least one reference signal to a terminal device UE; receiving reporting from the terminal device UE.

In an example, the receiving of the reporting includes at least one of: the at least one reference signal includes a first reference signal and a second reference signal, and when a measurement result of the first reference signal and a measurement result of the second reference signal satisfy the predetermined condition, receiving the reporting; the at least one reference signal includes the first reference signal, and when K measurement results of the first reference signal satisfy the predetermined condition, receiving the reporting.

In an example, the reporting is received via at least one of: a media access control control element MAC-CE; a physical random access channel PRACH; a scheduling request SR; a channel state information CSI report.

An aspect of the present disclosure provides a method performed by a base station in a wireless communication network, the method including: transmitting indication information to a terminal device UE, wherein the indication information includes transmission configuration indication TCI state indication information; and not performing reception or transmission with the UE in a first time period.

In an example, the indication information enables the UE not to be required to perform transmission or reception in the first time period, wherein the first time period is related to the indication information.

In an example, the first time period being related to the indication information includes one of: a start point of the first time period is based on a channel or signal carrying the indication information; the start point of the first time period is based on a channel or signal carrying a feedback corresponding to the indication information; an end point of the first time period is a slot of first cell(s); the end point of the first time period is related to reference signal transmission of the first cell(s); the end point of the first time period is related to PRACH transmission of the first cell; a length of the first time period is related to a subcarrier spacing SCS of a serving cell of the UE; the length of the first time period is related to an SCS of the first cell(s); wherein the indication information further includes information related to the first cell(s).

An aspect of the present disclosure provides a method performed by a base station in a wireless communication network, the method including: transmitting indication information to a terminal device UE in a second cell, wherein the indication information includes transmission configuration indication TCI state indication information and information of first cell(s); and performing transmission or reception with the UE.

In an example, the indication information enables the UE to perform at least one of the following behaviors in the first cell(s): applying the TCI state indication; triggering reference signal transmission; reporting channel state information CSI reporting; transmitting a physical random access channel PRACH; releasing a serving cell of the UE.

An aspect of the present disclosure provides a method performed by a base station in a wireless communication system, the method including: transmitting at least one reference signal information and information related to first cell(s) corresponding to the reference signal information; receiving a request corresponding to first reference signal information of the at least one reference signal information; transmitting a response to the request.

In an example, the response enables the UE to apply the first reference signal information in the first cell(s).

In an example, the response enables the UE to apply the first reference signal information after a second time period in which the response is received.

In an example, a length of the second time period is related to an SCS of a serving cell of the UE; or, a length of the second time period is related to an SCS of the first cell(s).

An aspect of the present disclosure provides a terminal device UE in a wireless communication system, the UE including: a transceiver; and a processor coupled to the transceiver, the processor configured to perform the methods that can be performed by the UE in the various aspects described above.

An aspect of the present disclosure provides a base station in a wireless communication system, the base station including: a transceiver; and a processor coupled to the transceiver, the processor configured to perform the various methods that can be performed by the base station in the various aspects described above.

### Advantageous Effects of Invention

The present disclosure provides a method and device for receiving and transmitting information/signals, which can improve the performance of cell switch.

### BRIEF DESCRIPTION OF DRAWINGS

The above and other aspects, features and advantages of the present invention will be more apparent from the following detailed description when taken in conjunction with the accompanying drawings.

FIG. 1 illustrates an overall structure of an example wireless communication network according to various embodiments of the present disclosure;

FIG. 2A illustrates a transmission path 200 in a wireless communication network according to various embodiments of the present disclosure;

FIG. 2B illustrates a reception path 250 in a wireless communication network according to various embodiments of the present disclosure;

FIG. 3A illustrates a structure of a user equipment (UE) in a wireless communication network according to various embodiments of the present disclosure;

FIG. 3B illustrates a structure of a base station in a wireless communication network according to various embodiments of the present disclosure;

FIG. 4 illustrates a method 400 performed by a UE to determine a timing of a reference signal according to various embodiments of the present disclosure;

FIG. 5 illustrates a method 500 performed by a UE to determine a purpose of a mobility reference signal according to various embodiments of the present disclosure;

FIG. 6 illustrates a method 600 performed by a UE for Layer 1 reporting for mobility according to various embodiments of the present disclosure;

FIG. 7 illustrates a method 700 for Layer 1 or Layer 2 reporting for mobility initiated by a UE according to various embodiments of the present disclosure;

FIG. 8 illustrates a method 800 performed by a UE to determine a handover occasion interruption time during dynamic cell switch according to various embodiments of the present disclosure;

FIG. 9 illustrates a method 900 for determining a behavior of a UE after dynamic cell switch according to various embodiments of the present disclosure;

FIG. 10 illustrates a method 1000 of cell switch initiated by a UE based on beam failure recovery according to various embodiments of the present disclosure;

FIG. 11 illustrates a structure 1100 of a UE according to various embodiments of the present disclosure;

FIG. 12 illustrates a structure 1200 of a base station according to various embodiments of the present disclosure.

### MODE FOR THE INVENTION

Hereinafter, embodiments of the present disclosure will be described in detail with reference to the accompanying drawings. It should be noted that in the drawings, the same or similar elements are denoted by the same or similar reference numerals as far as possible. In addition, detailed descriptions of known functions or configurations that may make the subject matter of the present disclosure unclear will be omitted.

When describing the embodiments of the present disclosure, descriptions related to technical contents that are well known in the art and not directly related to the present disclosure will be omitted. Such omitting of unnecessary description is to prevent the main idea of the present disclosure from being blurred and to convey the main idea more clearly.

For the same reason, some elements may be exaggerated, omitted or schematically shown in the drawings. In addition, the size of each element does not fully reflect the actual size. In the drawings, the same or corresponding elements have the same reference numerals.

Advantages and features of the present disclosure and ways to achieve them will become clear by referring to the embodiments described in detail below in conjunction with the accompanying drawings. However, the present disclosure is not limited to the embodiments set forth below, but can be implemented in various forms. The following examples are provided only to fully disclose the present disclosure and to inform those skilled in the art of its scope, and the present disclosure is only limited by the scope of the appended claims. Throughout this specification, the same or similar reference numerals indicate the same or similar elements.

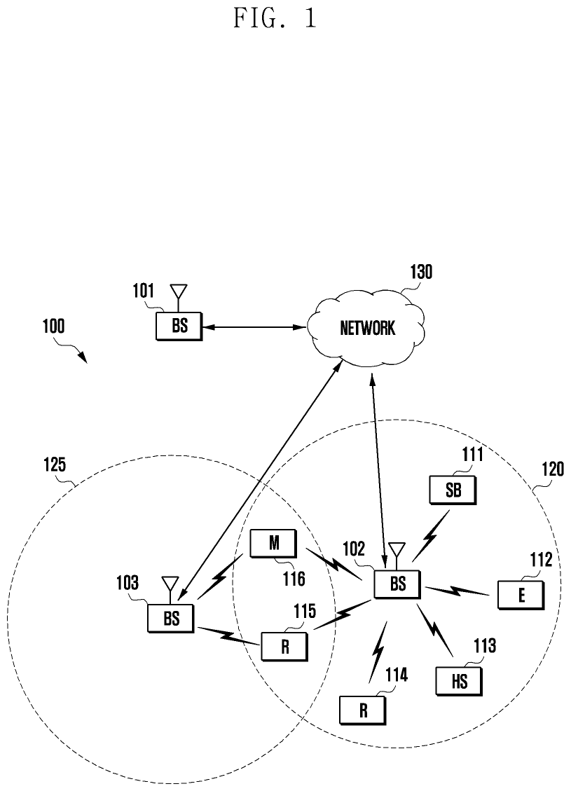

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

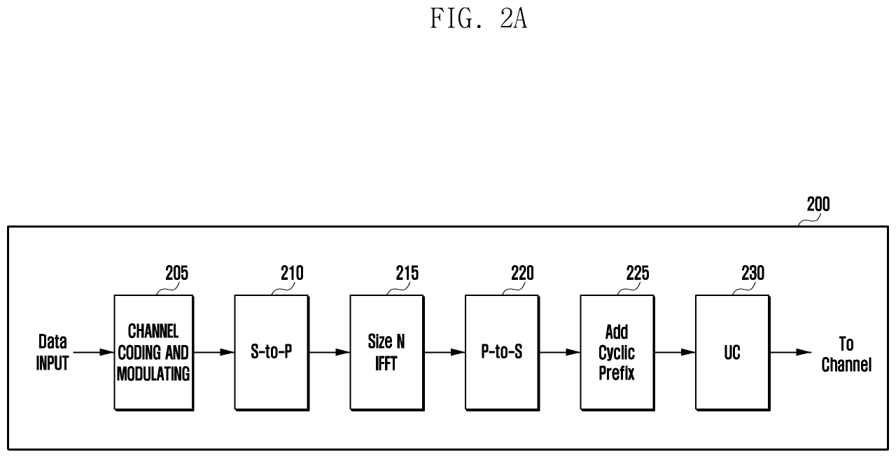

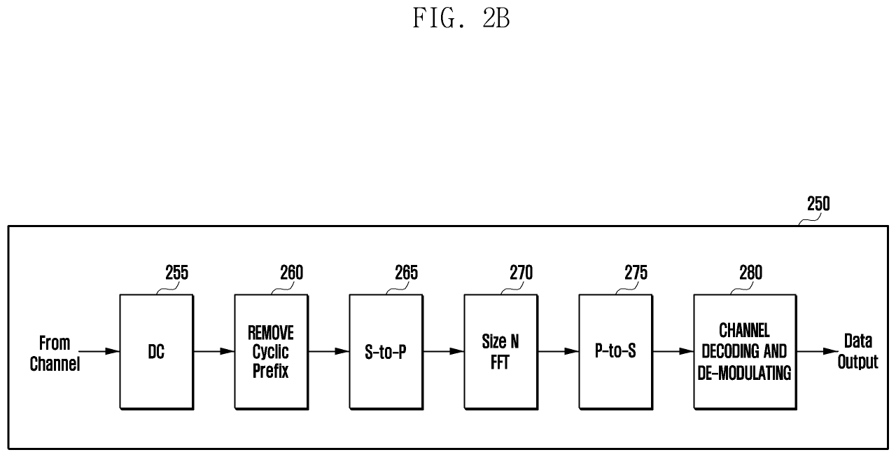

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

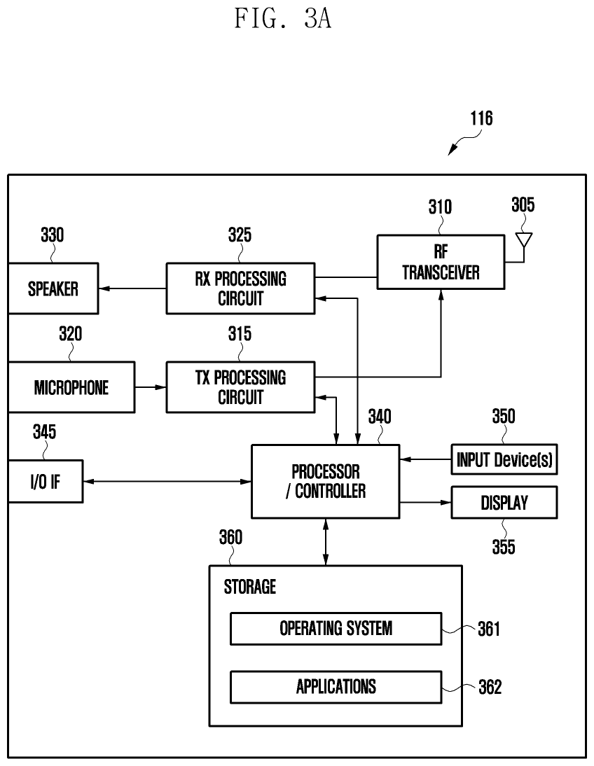

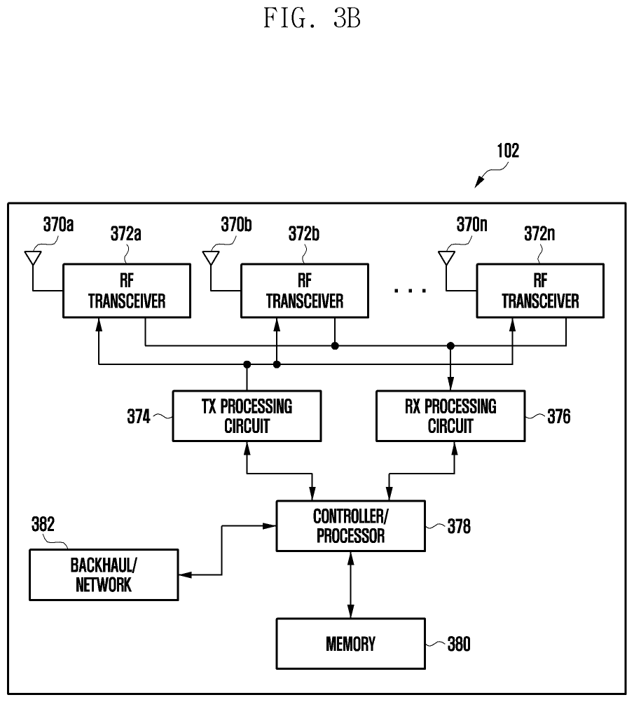

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The 5G wireless communication system supports mobility management. This enables the terminal device to maintain high-quality communication with the network device even when it is moving. However, when the moving speed of the terminal device is further improved, it will quickly pass through multiple cells. This means that the terminal device needs frequent cell switch. Therefore, there is a need for a method capable of improving cell switch performance and a device for performing the method.

The following is further explained by various embodiments.

### Embodiment 1 (Determine Timing of Reference Signal)

The method includes: receiving, by a terminal device, indication information on a reference signal from a base station; wherein the reference signal is related to first cell(s); determining, by the terminal device, a timing of the reference signal according to the indication information.

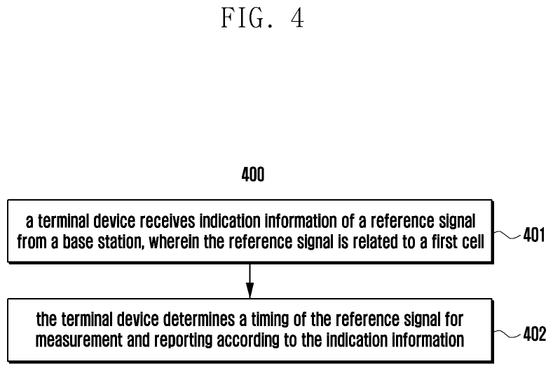

For example, FIG. 4 illustrates a method 400 performed by a UE to determine a timing of a reference signal according to various embodiments of the present disclosure, which includes: at 401, receiving, by a terminal device, indication information of a reference signal from a base station, wherein the reference signal is related to first cell(s); at 402, determining, by the terminal device, a timing of the reference signal for measurement and/or reporting according to the indication information.

Optionally, the reference signal is used for Layer 1 measurement. For example, the reference signal is used for Layer 1-Reference Signal Received Power (L1-RSRP) measurement and/or Layer 1-Signal to Interference plus Noise Ratio (L1-SINR) measurement.

Optionally, the reference signal refers to a channel state information-reference signal (CSI-RS) and/or synchronization signal (SSB). Optionally, the reference signal refers to at least one of: a tracking reference signal (TRS), a CSI-RS for beam management, a CSI-RS for CSI acquisition, and an RS for recovery.

Optionally, the TRS refers to a CSI-RS configured with TRS parameters (e.g., trs-info). The CSI-RS for beam management refers to a CSI-RS configured with repetition parameters (e.g., repetition) (optionally, the CSI-RS is not configured with TRS parameters). The CSI-RS for CSI acquisition refers to a CSI-RS configured with neither TRS parameters (e.g., trs-info) nor repetition parameters (e.g., repetition). The RS for recovery may be understood as a reference signal (or CSI-RS and/or SSB) for identifying the candidate beams for recovery. The RS for recovery may also be understood as a reference signal for link recovery or beam failure recovery.

Here, the receiving of the indication information of the reference signal from the base station by the terminal device is further illustrated. Here, the indication information of the reference signal refers to at least one of:
first timing indication information. Here, it may be understood that the first timing indication information is the indication information of the reference signal (or it may be called “configuration information of the reference signal”). Optionally, the indication information of the reference signal refers to quasi co-location (QCL) information of the reference signal. Optionally, the indication information of the reference signal refers to QCL type A reference signal (or it may be called “QCL source reference signal”) information of the reference signal. Optionally, the QCL type A reference signal corresponds to the first cell(s) (or an identifier (ID) of the first cell(s) or a physical cell identifier (PCI) of the first cell(s)). Optionally, the QCL type A reference signal refers to SSB, which corresponds to the first cell(s). Optionally, the PCI corresponding to the QCL type A reference signal is the same as that of a second cell (e.g., a serving cell). Optionally, the QCL type A reference signal refers to SSB, and the PCI corresponding to the SSB is the same as that of the second cell.
second timing indication information. Here, the second timing indication information may be understood as indicating whether the timing of the reference signal is based on a timing of the second cell. Here, the second timing indication information may also be understood as indicating whether the timing of the reference signal is based on the timing of the second cell or the timing of other cells.

Optionally, the second cell refers to a serving cell or a source cell (for example, a source cell for cell switch). The serving cell may be understood as a cell where the reference signal is located. Optionally, the serving cell may be understood as a cell in which the terminal device obtains the indication information of the reference signal.

Optionally, the ID of the first cell(s) may be understood as a PCI. Optionally, the ID of the first cell(s) refers to a PCI different from that of the second cell. Optionally, the first cell(s) refers to a candidate cell or a target cell. Optionally, the first cell(s) (or candidate cell/target cell) refers to a cell in which the terminal device receives the configuration information of the cell and which is not the second cell (or an existing serving cell). Optionally, the ID of the first cell(s) refers to a cell ID corresponding to the additional PCI configuration information (for example, SSB-MTCAdditionalPCI). Optionally, the target cell may be understood as a target cell for cell switch.

Optionally, the reference signal (or reference signal resource) being related to the first cell(s) may be understood as that: the QCL reference signal (or QCL source reference signal) corresponding to the reference signal corresponds to the first cell(s) (or the ID of the first cell(s) or the physical cell identifier (PCI) of the first cell(s)). Optionally, the reference signal and the first cell(s) may also be understood as that: the QCL type A reference signal and/or QCL type D reference signal corresponding to the reference signal correspond to the first cell(s). For example, the reference signal is CSI-RS, where the reference signal (or the QCL source reference signal) corresponding to the CSI-RS is SSB. The SSB corresponds to the first cell(s) (or the PCI of the cell corresponding to the SSB is different from that of the second cell). Optionally, the above SSB is the above QCL type D reference signal of the CSI-RS. Optionally, the above SSB is the above QCL type A reference signal of the CSI-RS.

How the terminal device determines the timing of the reference signal according to the indication information is further illustrated below. The specific methods are as follows:

### Method 1 (First Timing Indication Information)

When the QCL reference signal (for example, the QCL type A reference signal) of the reference signal corresponds to the first cell(s), the terminal device determines the timing of the reference signal according to the timing of the first cell(s) (or the cell of PCI corresponding to the QCL reference signal).

Optionally, in other cases (for example, when the QCL reference signal (for example, the QCL type A reference signal) of the reference signal does not correspond to the first cell(s) (or the corresponding PCI is the same as that of the second cell)), the terminal device determines the timing of the reference signal according to the timing of the second cell.

### Method 2 (Second Timing Indication Information)

When the indication information of the reference signal received by the terminal device indicates that the timing of the reference signal is not the timing of the second cell, the terminal device determines the timing of the reference signal according to the timing of the cell of PCI corresponding to the QCL reference signal (for example, the QCL type A reference signal) of the reference signal.

Optionally, when the indication information of the reference signal received by the terminal device (explicitly) indicates that the timing of the reference signal is the timing of the second cell, the terminal device determines the timing of the reference signal according to the timing of the second cell.

Optionally, when the indication information of the reference signal received by the terminal device (explicitly) indicates that the timing of the reference signal is the timing of other cells (for example, cells other than the second cell), the terminal device determines the timing of the reference signal according to the timing of the cell of PCI corresponding to the QCL type A reference signal of the reference signal.

In the above two methods, the QCL reference signal (for example, QCL source reference signal, QCL type A reference signal, or QCL type D reference signal) may be understood as SSB or CSI-RS.

Advantageous effects of Embodiment 1: a method for determining the timing of the reference signal is provided in Embodiment 1. The method can help the terminal device to correctly determine the timing of the reference signal in a case that the timing of the reference signal is not synchronous (that is, asynchronous) with the cell to switch to, which is convenient for the terminal device to carry out cell switch related measurements, thus improving the performance of the communication system.

### Embodiment 2 (Determine Mobility Reference Signal for Performing Layer 1 Measurement and/or Layer 3 Measurement)

The method includes: receiving, by a terminal device, indication information on a mobility reference signal from a base station; determining, by the terminal device, that the mobility reference signal is used for Layer 1 measurement and/or Layer 3 measurement according to the indication information.

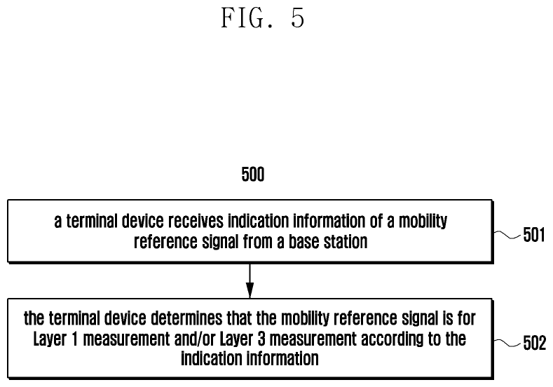

For example, FIG. 5 illustrates a method 500 performed by a UE to determine a purpose of a mobility reference signal according to various embodiments of the present disclosure, which includes: at 501, receiving, by a terminal device, indication information of a mobility reference signal from a base station; at 502, determining, by the terminal device, that the mobility reference signal is used for Layer 1 measurement and/or Layer 3 measurement according to the indication information.

Optionally, the terminal device performs the Layer 1 measurement and/or the Layer 3 measurement according to the mobility reference signal.

Here, the indication information may be understood as at least one of:
first indication information (or it may also be called “first configuration information”). The first indication information may be understood as indicating the purpose of the mobility reference signal. For example, the mobility reference signal is used for the Layer 1 measurement, Layer 3 measurement, or Layer 1 measurement and Layer 3 measurement.
second indication information (or it may also be called “second configuration information”). Here, the second indication information may be understood as the indication information of the mobility reference signal (or it may be called “configuration information of the mobility reference signal”). The second indication information may also be understood as that the indication information of the mobility reference signal is not indicated or configured with the purpose of the mobility reference signal (or, the indication information of the mobility reference signal is not configured for the Layer 1 and/or Layer 3 measurement).

Optionally, the indication information of the mobility reference signal being not indicated or configured with the purpose of the mobility reference signal (or being indicated or configured with the purpose of the mobility reference signal) may be configured or indicated by purpose indication information included in the second indication information or different from the second indication information.

How the terminal device determines that the mobility reference signal is used for the Layer 1 measurement and/or the Layer 3 measurement according to the indication information is further illustrated below. The specific determination method is as follows:

### Method 1 (First Indication Information)

When the terminal device receives the indication information and the indication information corresponds to Layer 1, the terminal device determines that the mobility reference signal is used for the Layer 1 measurement.

### Method 2 (First Indication Information)

When the terminal device receives the indication information and the indication information corresponds to Layer 3, the terminal device determines that the mobility reference signal is used for the Layer 3 measurement.

### Method 3 (First Indication Information)

When the terminal device receives the indication information and the indication information corresponds to Layer 1 and Layer 3, the terminal device determines that the mobility reference signal is used for both the Layer 1 measurement and the Layer 3 measurement.

### Method 4 (Second Indication Information)

When the terminal device receives the indication information of the mobility reference signal, and the mobility reference signal (or the indication information of the mobility reference signal) is not indicated or configured with the purpose indication information (for example, it is not indicated or configured for the Layer 1 measurement and/or the Layer 3 measurement), the terminal device determines that the mobility reference signal is used for the Layer 3 measurement.

Optionally, the terminal device supports both the Layer 1 measurement and the Layer 3 measurement using the mobility reference signal.

Optionally, the terminal device reports terminal device capability signaling. The terminal device capability signaling indicates that the terminal device supports both the Layer 1 measurement and the Layer 3 measurement using the mobility reference signal.

### Method 5 (Second Indication Information)

When the terminal device receives the indication information of the mobility reference signal, and the mobility reference signal (or the indication information of the mobility reference signal) is not indicated or configured with the purpose indication information (for example, it is not indicated or configured for the Layer 1 measurement and/or the Layer 3 measurement), the terminal device determines that the mobility reference signal is used for the Layer 1 measurement.

Optionally, the terminal device supports both the Layer 1 measurement and the Layer 3 measurement using the mobility reference signal.

Optionally, the terminal device reports the terminal device capability signaling. The terminal device capability signaling indicates that the terminal device supports both the Layer 1 measurement and the Layer 3 measurement using the mobility reference signal.

A method for determining the timing of the mobility reference signal (this method may be combined with methods 1 to 5 for determining that the mobility reference signal is used for the Layer 1 measurement and/or the Layer 3 measurement described above) is described below:

Optionally, the terminal device determines the timing of the mobility reference signal. Optionally, after determining the purpose of the mobility reference signal, the terminal device determines the timing of the mobility reference signal. The method for the terminal device to determine the timing of the mobility reference signal is as one of:
when the terminal device receives the indication information of the mobility reference signal and the indication information is not configured with SSB related to the mobility reference signal, the terminal device determining the timing of the mobility reference signal based on the timing of the second cell.
when the terminal device receives the indication information of the mobility reference signal and the indication information is configured with SSB related to the mobility reference signal, the terminal device determining the timing of the mobility reference signal based on a timing corresponding to the cell ID (for example, cellId) in the indication information.

It should be noted that the mobility reference signal may be understood as the CSI-RS for mobility.

Advantageous effects of Embodiment 2: a method for determining the purpose of the mobility reference signal is provided in Embodiment 2. The method can help the terminal device to determine that the mobility reference signal is used for Layer 1 measurement and/or Layer 3 measurement, therefore, the terminal device can reduce the reference signal overhead for measurement by using the mobility reference signal for the Layer 1 and/or the Layer 3 measurement. In addition, this method can effectively use the reference signal resources, that is, for a mobility reference signal, it can be used for both the Layer 1 measurement and the Layer 3 measurement, which improves the efficiency of the system.

### Embodiment 3 (L1 Report for Mobility)

The method includes: receiving, by a terminal device, configuration information; reporting, by the terminal device, reference signal information and indicator(s) corresponding to the reference signal information according to the configuration information.

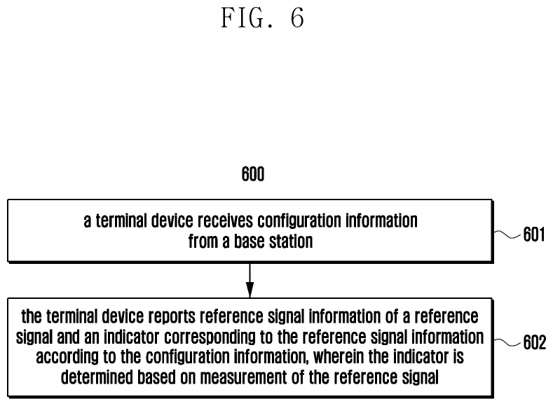

For example, FIG. 6 illustrates a method 600 performed by a UE for Layer 1 reporting for mobility according to various embodiments of the present disclosure, which includes: at 601, receiving, by a terminal device, configuration information from a base station; at 602, reporting, by the terminal device, reference signal information of reference signal(s) and indicator(s) corresponding to the reference signal information according to the configuration information.

Optionally, the configuration information may be understood as reporting configuration information, for example, CSI reporting configuration information.

Optionally, the reporting is periodic, semi-persistent or aperiodic.

Optionally, the terminal device further reports L1-RSRP and/or L1-SINR corresponding to the reference signal information.

Optionally, the reference signal information may be understood as reference signal resource information, for example, SSB resource ID (SSBRI) and/or CSI-RS resource ID (CRI).

Optionally, the reference signal information and the indicator are in one-to-one mapping. For example, the reporting of the reference signal information is based on measurement of group(s) of reference signals. The terminal device determines to report reference signal information corresponding to N reference signals with the highest measured values according to the configuration information (or indication information) from the base station; where N is, for example, 1, 2, 3, 4. Here, each reported reference signal information corresponds to an indicator.

Optionally, the reference signal information corresponds to the highest measured value(s). For example, the reporting of the reference signal information is based on the measurement of a group of reference signals. The terminal device determines to report reference signal information corresponding to N reference signals with the highest L1-RSRP(s) according to the configuration information from the base station; where N is, for example, 1, 2, 3, 4. Optionally, N is predefined (for example, 1). Optionally, when N=1, the reference signal information associated with the highest L1-RSRP(s) corresponds to an indicator. Optionally, the reference signal information associated with the highest L1-RSRP(s) corresponds to an indicator.

Optionally, the indicator may be understood as a cell indicator, or the indicator is used to indicate whether a cell corresponding to the corresponding reference signal information satisfies a cell switch condition (or whether cell switch can be performed). Optionally, the cell switch may be understood as dynamic cell switch. The method for determining the indicator is further described below (the following methods 1 to 3 may be used in combination):

### Method 1

Optionally, if the reference signal information corresponds to the second cell, the indicator corresponds to a specific value (for example, 0, 1, etc.). Here, the reference signal information corresponding to the second cell may be understood as that the reference signal (or reference signal resource) corresponding to the reference signal information corresponds to the second cell. Optionally, the reference signal (or reference signal resource) corresponding to the second cell may be understood as that the reference signal (or reference signal resource) is not associated with cells other than the second cell. For example, when the terminal device reports a CRI (for example, CRI #1) which corresponds to the second cell (or CSI-RS configuration information corresponding to the CRI corresponds to the second cell), the value of the indicator corresponding to the CRI is 0. For another example, the terminal device reports an SSBRI (for example, SSBRI #1) which corresponds to the second cell (or, the SSB corresponding to the SSBRI corresponds to the second cell; or, the SSB corresponding to the SSBRI corresponds to the second cell PCI), the value of the indicator corresponding to the SSBRI is 0.

Optionally, the above second cell refers to a serving cell or a source cell (for example, a source cell for cell switch). The serving cell may be understood as a cell where the reference signal is located. Optionally, the serving cell may be understood as a cell in which the terminal device obtains the indication information of the reference signal.

### Method 2

If the reference signal information is related to the first cell(s), the indicator(s) is determined according to the measurement of the reference signal corresponding to the reference signal information.

Optionally, the ID of the first cell(s) may be understood as a PCI. Optionally, the ID of the first cell(s) refers to a PCI different from that of the second cell. Optionally, the first cell(s) refers to a candidate cell or a target cell. Optionally, the first cell(s) (or candidate cell/target cell) refers to a cell in which the terminal device receives the configuration information of the cell and which is not the second cell (or an existing serving cell). Optionally, the ID of the first cell(s) refers to a cell ID corresponding to the additional PCI configuration information (for example, SSB-MTCAdditionalPCI). Optionally, the target cell may be understood as a target cell for cell switch.

### Method 3

The indicator(s) is determined according to the measurement of the reference signal corresponding to the reference signal information.

“The indicator(s) is determined according to the measurement of the reference signal corresponding to the reference signal information” is further explained below. The specific methods are as follows (the following methods 1 and method 2 may be used in combination):

### Method 1

The indicator(s) is determined according to the measurement of the reference signal corresponding to the reference signal information and the measurement of the reference signal corresponding to the second cell. Optionally, the reference signal corresponding to the reference signal information corresponds to the first cell(s). Optionally, the reference signal corresponding to the reference signal information and the reference signal corresponding to the second cell correspond to the same reference signal resource group. Optionally, the measured value(s) of the reference signal corresponding to the reference signal information is greater than or equal to the measured value(s) of the reference signal corresponding to the second cell. Optionally, the difference between the measured value(s) of the reference signal corresponding to the reference signal information and the measured value(s) of the reference signal corresponding to the second cell in the measurement resource group is greater than or equal to a specific threshold. Optionally, the threshold is predefined, indicated by the base station, or related to the terminal device capability. Optionally, the measured value(s) of the reference signal corresponding to the second cell refers to the highest measured value(s) among the measured values of one or more reference signals corresponding to the second cell.

For example, the terminal device obtains the reporting configuration information. The reporting configuration information corresponds to a group of reference signal resources (or reference signal resources for measurement); the reference signal resources correspond to the second cell and the first cell(s) (or, a part of the reference signal resources correspond to the second cell and the other part of the reference signal resources correspond to the first cell(s)). Optionally, the group of resources includes CRI #1, CRI #2, CRI #3, CRI #4, CRI #5 and CRI #6. CRI #1 and CRI #2 correspond to second cells (for example, cells Cell #1 and Cell #2); CRI #3, CRI #4, CRI #5 and CRI #6 correspond to the first cell(s) (for example, Cell #3, Cell #4, Cell #5 and Cell #6 respectively). In addition, the measured values (or the measured values of the reference signal resources) corresponding to CRI #1, CRI #2, CRI #3, CRI #4, CRI #5 and CRI #6 are M #1, M #2, M #3, M #4, M #5 and M #6, respectively. The terminal device reports the reference signal information (for example, the highest N measured values, where the definition of N is shown above) according to these measured values. If the reference signal corresponding to one reference signal information for reporting corresponds to the second cell (for example, CRI #1), the indicator corresponding to the reference signal information is a specific value (for example, 0). If the reference signal corresponding to one reference signal information for reporting corresponds to the first cell(s) (for example, CRI #3), the indicator corresponding to CRI #3 is determined according to M #3 and the measured values (for example, M #1, M #2) of the reference signals corresponding to the second cell in the above reference signal group. Optionally, the indicator corresponding to CRI #3 is determined according to M #3−max(M #1, M #2). When M #3−max(M #1, M #2) is greater than or equal to a threshold T, the indicator is 1; and when M #3−max(M #1, M #2) is less than or equal to the threshold T, the indicator is 0. Here, the threshold T may be predefined, for example, 3 dB and 6 dB. Here, the threshold T may also be indicated by the base station. Here, the threshold T may also be related to the terminal capability (for example, the value of T is reported to the base station through terminal capability signaling).

For another example, the terminal device obtains the reporting configuration information. The reporting configuration information corresponds to two groups of reference signal resources (or, two groups of reference signal resources for measurement, Group #1 and Group #2); the first group of reference signal resources corresponds to the second cell; the second group of reference signal resources corresponds to the first cell(s). Optionally, the reference signal resources of Group #1 include CRI #1 and CRI #2; the reference signal resources of Group #2 include CRI #3, CRI #4, CRI #5 and CRI #6. Group #1, that is, CRI #1 and CRI #2, corresponds to the second cell; Group #2, that is, CRI #3, CRI #4, CRI #5 and CRI #6, corresponds to the first cell(s) (for example, Cell #3, Cell #4, Cell #5 and Cell #6, respectively). In addition, the measured values (or the measured values of the reference signal resources) corresponding to CRI #1, CRI #2, CRI #3, CRI #4, CRI #5 and CRI #6 are M #1, M #2, M #3, M #4, M #5 and M #6, respectively. The terminal device reports the reference signal information (for example, the highest N measured values related to Group #2, where the definition of N is shown above) according to these measured values. Further, if the terminal device reports CRI #3, the indicator corresponding to CRI #3 is determined according to M #3 and the measured values (for example, M #1 and M #2) of the reference signals corresponding to the second cell in the above reference signal group. Optionally, the indicator corresponding to CRI #3 is determined according to M #3−max(M #1, M #2). When M #3−max(M #1, M #2) is greater than or equal to the threshold T, the indicator is 1; and when M #3−max(M #1, M #2) is less than or equal to the threshold T, the indicator is 0. Here, the threshold T may be predefined, for example, 3 dB and 6 dB. Here, the threshold T may also be indicated by the base station. Here, the threshold T may also be related to the terminal capability (for example, the value of T is reported to the base station through terminal capability signaling).

### Method 2

The indicator is determined according to K measurements of the reference signal corresponding to the reference signal information.

Optionally, when at least one of the K measurements satisfies a first condition, the indicator is a specific value (for example, 1); otherwise, the indicator is another specific value (for example, 0).

Optionally, when each of the K measurements satisfies the first condition, the indicator is a specific value (for example, 1); otherwise, the indicator is another specific value (for example, 0).

Optionally, the K measurements refer to the latest K measurements. Optionally, the K measurements are before (or not later than) the CSI reference resource, that is, the K measurements are completed before a position of the CSI reference resource. Optionally, K measurements refer to consecutive K measurements. Optionally, the K measurements refer to the latest consecutive K measurements before (or not later than) the CSI reference resource.

Optionally, a length of a measurement window corresponding to the K measurements is predefined. Optionally, the length of the measurement window corresponding to the K measurements is indicated by the base station. Optionally, the length of the time window corresponding to the K measurements is related to periodicity of the reference signal (or, the length of the time window corresponding to the K measurements is a multiple of the periodicity of the reference signal, for example, the length of the time window corresponding to the K measurements is the periodicity of the reference signal).

Here, K may be predefined, for example, one of 1, 2, 3, 4, 5, 6, 7 and 8. In addition, K may also be indicated by the base station. In addition, K may also be related to the terminal device capability, that is, it is reported through terminal capability signaling.

How a measurement satisfies the first condition is further illustrated below. Optionally, a measurement satisfying the first condition may be understood as that a measurement satisfies the first condition in an above-mentioned time window. Optionally, satisfying the first condition may be understood as that the measured value of the reference signal corresponding to the reference signal information is greater than or equal to the measured value of the reference signal corresponding to the second cell. Optionally, satisfying the first condition may be understood as that the difference between the measured value of the reference signal corresponding to the reference signal information and the measured value of the reference signal corresponding to the second cell in the measurement resource group is greater than or equal to a specific threshold. Optionally, the measured value of the reference signal corresponding to the second cell refers to the highest measured value of the reference signal corresponding to the second cell in a reference signal resource group.

The following is a specific example.

For example, the terminal device obtains the reporting configuration information. The reporting configuration information corresponds to a group of reference signal resources (or reference signal resources for measurement); the reference signal resources correspond to the second cell and the first cell(s) (or, a part of the reference signal resources correspond to the second cell and the other part of the reference signal resources correspond to the first cell(s)). Optionally, the group of resources includes CRI #1, CRI #2, CRI #3, CRI #4, CRI #5 and CRI #6. CRI #1 and CRI #2 correspond to the second cell (for example, Cell #1); CRI #3, CRI #4, CRI #5 and CRI #6 correspond to the first cell(s) (for example, Cell #3, Cell #4, Cell #5 and Cell #6, respectively). The terminal device reports the reference signal information (for example, the highest N measured values, where the definition of N is shown above) according to the measured values corresponding to CRI #1, CRI #2, CRI #3, CRI #4, CRI #5 and CRI #6. When the terminal device reports the reference signal information (for example, the reference signal information corresponding to the first cell(s), CRI #3), and K measurements corresponding to CRI #3 all satisfy the first condition (for example, the latest consecutive K measurements before the CSI reference resource all satisfy the first condition), the indicator corresponding to CRI #3 is 1; otherwise, it is 0. Here, the understanding of a measurement corresponding to CRI #3 satisfying the first condition is as follows:

For a measurement, or in a measurement window, the measured values (or the measured values of the reference signal resources) corresponding to CRI #1, CRI #2, CRI #3, CRI #4, CRI #5 and CRI #6 are M #1, M #2, M #3, M #4, M #5 and M #6, respectively. Whether a measurement corresponding to CRI #3 satisfies the first condition is determined according to M #3 and the measured values (e.g., M #1 and M #2) of the reference signals corresponding to the second cell in the above reference signal group. Optionally, whether a measurement corresponding to CRI #3 satisfies the first condition is determined according to M #3−max(M #1, M #2). When M #3−max(M #1, M #2) is greater than or equal to the threshold T, the measurement corresponding to CRI #3 satisfies the first condition; and when M #3−max(M #1, M #2) is less than or equal to the threshold T, the measurement corresponding to CRI #3 does not satisfy the first condition. Here, the threshold T may be predefined, for example, 3 dB, 6 dB. Here, the threshold T may also be indicated by the base station. Here, the threshold T may also be related to the terminal capability (for example, the value of T is reported to the base station through terminal capability signaling).

Here, the measured value may be understood as L1-RSRP; it may also be understood as L1-SINR; it may also be understood as the measured value of L1-RSRP; it may also be understood as the measured value of L1-SINR.

In Embodiment 3, the ID of the first cell(s) may be understood as a PCI. Optionally, the ID of the first cell(s) refers to a PCI different from that of the second cell. Optionally, the first cell(s) refers to a candidate cell or a target cell. Optionally, the first cell(s) (or candidate cell/target cell) refers to a cell in which the terminal device receives the configuration information of the cell and which is not the second cell (or an existing serving cell). Optionally, the first cell(s) refers to a cell corresponding to additional PCI configuration information (for example, SSB-MTCAdditionalPCI). Optionally, the target cell may be understood as a target cell for cell switch.

In Embodiment 3, the second cell refers to a serving cell or a source cell (for example, a source cell for cell switch). The serving cell may be understood as a cell where the reference signal is located. Optionally, the serving cell may be understood as a cell in which the terminal device obtains the indication information of the reference signal.

Advantageous effects of Embodiment 3: a method for reporting the cell indicator is provided in Embodiment 3. The method enables the terminal device to determine to report the cell indicator by measuring the reference signal. Therefore, the base station can determine which cell is suitable for dynamic cell switch by receiving the cell indicator, thus improving the accuracy of cell switch.

### Embodiment 4 (UE Initiated L1/L2 Report for Mobility)

The method includes: receiving, by a terminal device, reporting configuration information; triggering, by the terminal device, the reporting according to measurement of a first reference signal and a second reference signal.

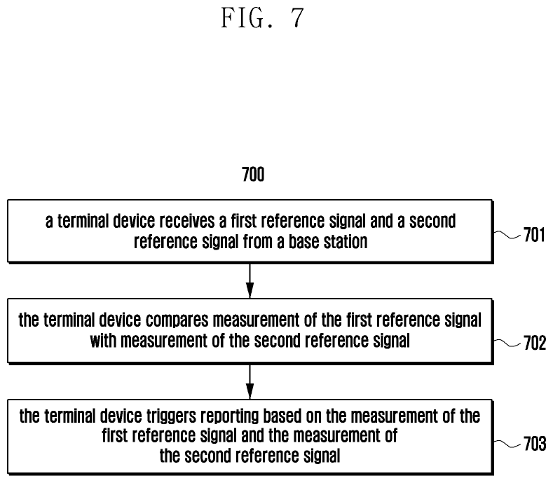

For example, FIG. 7 illustrates a method 700 for Layer 1 or Layer 2 reporting for mobility initiated by UE according to various embodiments of the present disclosure, which includes: at 701, receiving, by a terminal device, a first reference signal and a second reference signal from a base station; at 702, comparing, by the terminal device, measurement of the first reference signal with measurement of the second reference signal; at 703, triggering, by the terminal device, reporting based on the measurement of the first reference signal and the measurement of the second reference signal.

Here, the second reference signal may be understood as a reference signal of the second cell. The second reference signal may also be understood as a reference signal corresponding to the second cell.

Optionally, the second cell refers to a serving cell or a source cell (for example, a source cell for cell switch). The serving cell may be understood as a cell where the reference signal is located. Optionally, the serving cell may be understood as a cell in which the terminal device obtains the indication information of the reference signal.

Here, the first reference signal is associated with (or corresponds to) the first cell(s).

Optionally, the first cell(s) refers to a cell whose PCI is different from that of the second cell. Optionally, the first cell(s) refers to a candidate cell or a target cell. Optionally, the first cell(s) (or candidate cell/target cell) refers to a cell in which the terminal device receives the configuration information of the cell and which is not the second cell (or an existing serving cell). Optionally, the first cell(s) refers to a cell corresponding to additional PCI configuration information (for example, SSB-MTCAdditionalPCI). Optionally, the target cell may be understood as a target cell for cell switch.

Optionally, the first reference signal and/or the second reference signal are used to identify candidate beams for recovery.

Optionally, the reporting includes reporting the first reference signal and/or reference signal information and/or cell information of the first reference signal. Optionally, the cell information corresponds to one or more cells. Optionally, the cell information refers to information of the first cell(s) (for example, the ID of the first cell(s)).

Optionally, the terminal device may report through at least one of:
MAC-CE. Optionally, the MAC-CE is carried by a PUSCH. Optionally, if the MAC-CE has no corresponding uplink resources, a scheduling request (SR) is triggered. Optionally, the SR is used to obtain uplink resources for transmitting the cell information. Optionally, the MAC-CE is used for beam failure recovery (or link recovery).
physical random access channel PRACH. Optionally, the PRACH corresponds to a dedicated PRACH resource. Optionally, the PRACH is used for non-contention random access (CFRA) (or CFRA procedure). Optionally, the PRACH is used for beam failure recovery (or link recovery).
SR. Optionally, the SR is carried by a PUCCH. Optionally, the SR is used for beam failure recovery (or link recovery).
CSI report. Optionally, the CSI report is carried by a physical uplink shared channel (PUSCH) or a physical uplink control channel (PUCCH).

Here, the specific method for the terminal device to trigger the reporting according to the measurement of the first reference signal and the measurement of the second reference signal is as follows:

### Method 1

The triggering of the reporting by the terminal device is determined according to the measurement of the first reference signal and the measurement of the second reference signal. Optionally, the first reference signal and the second reference signal correspond to the same reference signal resource group. Optionally, the measured value of the first reference signal is greater than or equal to the measured value of the second reference signal. Optionally, the difference between the measured value of the first reference signal and the measured value of the second reference signal is greater than or equal to a specific threshold. Optionally, the threshold is predefined, indicated by the base station, or related to the terminal device capability. Optionally, the measured value of the first reference signal refers to the highest measured value among the measured values of one or more reference signals corresponding to the first reference signal.

For example, the terminal device obtains the reporting configuration information. The reporting configuration information corresponds to a group of reference signal resources (or reference signal resources for measurement); the reference signal resources include first reference signal resources and second reference signal resources. Here, the reference signal may be CSI-RS resources and/or SSB. CSI-RS is taken as an example below. Optionally, the group of resources includes CSI-RS Resource #1, CSI-RS Resource #2, CSI-RS Resource #3, CSI-RS Resource #4, CSI-RS Resource #5 and CSI-RS Resource #6. The first reference signal resources are CSI-RS Resource #1 and CSI-RS Resource #2, which correspond to the second cell; the second reference signal resources are CSI-RS Resource #3, CSI-RS Resource #4, CSI-RS Resource #5 and CSI-RS Resource #6, which correspond to the first cell(s). In addition, the measured values (or the measured values of the reference signal resources) corresponding to CSI-RS Resource #1, CSI-RS Resource #2, CSI-RS Resource #, CSI-RS Resource #4, CSI-RS Resource #5 and CSI-RS Resource #6 are M #1, M #2, M #3, M #4, M #5 and M #6, respectively. If at least one of the first reference signal resources satisfies the second condition (for example, CSI-RS Resource #3 satisfies the second condition), the terminal device triggers the reporting. Optionally, CSI-RS Resource #3 satisfying the second condition means that, when M #3−max(M #1, M #2) is greater than or equal to the threshold T, the terminal device triggers the reporting. Here, the threshold T may be predefined, for example, 3 dB and 6 dB. Here, the threshold T may also be indicated by the base station. Here, the threshold T may also be related to the terminal capability (for example, the value of T is reported to the base station through terminal capability signaling). Optionally, the reporting is carried by the MAC-CE. Optionally, what should be reported is the reference signal resource information (for example, one or all of the reference signal resource information satisfying the above second condition), that is, the corresponding reference signal resource information should be reported, or what should be reported includes the reference signal resource information. For example, if both CSI-RS Resource #3 and CSI-RS Resource #4 satisfy the second condition, one of the reference signal information corresponding to CSI-RS Resource #3 and CSI-RS Resource #4 is reported. For another example, if both CSI-RS Resource #3 and CSI-RS Resource #4 satisfy the second condition, the reference signal information corresponding to CSI-RS Resource #3 and CSI-RS Resource #4 is reported. Optionally, what should be reported is the cell information (for example, the information of the cell corresponding to the reference signal resource satisfying the above second condition). For example, if both CSI-RS Resource #3 and CSI-RS Resource #4 satisfy the second condition, one of the cell information Cell #3 and Cell #4 corresponding to CSI-RS Resource #3 and CSI-RS Resource #4 is reported. For another example, if both CSI-RS Resource #3 and CSI-RS Resource #4 satisfy the second condition, the cell information Cell #3 and Cell #4 corresponding to CSI-RS Resource #3 and CSI-RS Resource #4 are reported.

For another example, the above first reference signal resources and second reference signal resources correspond to a reference signal resource group respectively.

### Method 2

The triggering of the reporting by the terminal device is determined according to K measurements of the first reference signal and the measurement of the second reference.

Optionally, when at least one of the K measurements satisfies the first condition, the terminal device triggers the reporting.

Optionally, when each of the K measurements satisfies the first condition, the terminal device triggers the reporting.

Optionally, the K measurements refer to the latest K measurements. Optionally, the K measurements are before the above reporting. Optionally, the K measurements refer to consecutive K measurements. Optionally, the K measurements refer to the latest consecutive K measurements before the reporting. In addition, before the reporting may be understood as before a period of time (T) from the reporting; where T is indicated by the base station, predefined, or related to the terminal device capability. Here, T may be understood as the processing time of the terminal device.

Optionally, a length of a measurement window corresponding to the K measurements is predefined. Optionally, the length of the measurement window corresponding to the K measurements is indicated by the base station. Optionally, the length of the time window corresponding to the K measurements is related to periodicity of the reference signal (or, the length of the time window corresponding to the K measurements is a multiple of the periodicity of the reference signal, for example, the length of the time window corresponding to the K measurements is the periodicity of the reference signal).

Here, K may be predefined, for example, one of 1, 2, 3, 4, 5, 6, 7 and 8. In addition, K may also be indicated by the base station. In addition, K may also be related to the terminal device capability, that is, it is reported through terminal capability signaling.

How a measurement satisfies the first condition is further illustrated below. Optionally, a measurement satisfying the first condition may be understood as that a measurement satisfies the first condition in a time window. Optionally, satisfying the first condition may be understood as that the measured value of the first reference signal is greater than or equal to the measured value of the second reference signal. Optionally, satisfying the first condition may be understood as that the difference between the measured value of the first reference signal and the measured value of the second reference signal is greater than or equal to a specific threshold. Optionally, the measured value of the second reference signal refers to the highest measured value among the measured values of one or more reference signals corresponding to the second cell.

The following is a specific example.

For example, the terminal device obtains the reporting configuration information. The reporting configuration information corresponds to a group of reference signal resources (or reference signal resources for measurement); the reference signal resources include first reference signal resources and second reference signal resources. Here, the reference signal may be CSI-RS resources and/or SSB. CSI-RS is taken as an example below. Optionally, the group of resources includes CSI-RS Resource #1, CSI-RS Resource #2, CSI-RS Resource #3, CSI-RS Resource #4, CSI-RS Resource #5 and CSI-RS Resource #6. The first reference signal resources are CSI-RS Resource #1 and CSI-RS Resource #2, which correspond to the second cell; the second reference signal resources are CSI-RS Resource #3, CSI-RS Resource #4, CSI-RS Resource #5 and CSI-RS Resource #6, which correspond to the first cell(s). In addition, the measured values (or the measured values of the reference signal resources) corresponding to CSI-RS Resource #1, CSI-RS Resource #2, CSI-RS Resource #3, CSI-RS Resource #4, CSI-RS Resource #5 and CSI-RS Resource #6 are M #1, M #2, M #3 M #4, M #5 and M #6, respectively. When K measurements corresponding to CSI-RS Resource #3 all satisfy the first condition (for example, when the latest consecutive K measurements before a period of time T of the reporting all satisfy the first condition), the terminal device triggers the reporting. Here, the understanding of a measurement corresponding to CSI-RS Resource #3 satisfying the first condition is as follows:

For a measurement, or in a measurement window, the measured values (or the measured values of the reference signal resources) corresponding to CSI-RS Resource #1, CSI-RS Resource #2, CSI-RS Resource #3, CSI-RS Resource #4, CSI-RS Resource #5 and CSI-RS Resource #6 are M #1, M #2, M #3, M #4, M #5 and M #6, respectively. Whether a measurement corresponding to CSI-RS Resource #3 satisfies the first condition is determined according to M #3 and the measured values of the second reference signal (for example, M #1, M #2). Optionally, whether a measurement corresponding to CSI-RS Resource #3 satisfies the first condition is determined according to M #3−max(M #1, M #2). When M #3−max(M #1, M #2) is greater than or equal to the threshold T, the measurement corresponding to CSI-RS Resource #3 satisfies the first condition. Here, the threshold T may be predefined, for example, 3 dB and 6 dB. Here, the threshold T may also be indicated by the base station. Here, the threshold T may also be related to the terminal capability (for example, the value of T is reported to the base station through terminal capability signaling).

Here, the measured value may be understood as L1-RSRP; it may also be understood as L1-SINR; it may also be understood as the measured value of L1-RSRP; it may also be understood as the measured value of L1-SINR.

Optionally, the terminal device triggers the reporting according to the measurement of the first reference signal and the measurement of the second reference signal, and also according to the beam failure detection. That is, when the terminal device detects beam failure and the measurement of the first reference signal and the measurement of the second reference signal satisfy the conditions described above, the terminal device triggers the reporting. Optionally, the reporting may be understood as a beam failure recovery request. Optionally, the beam failure request corresponds to the second reference signal.

Advantageous effects of Embodiment 4: a method for triggering the cell switch reporting is provided in Embodiment 4. The method enables the terminal device to trigger the cell switch reporting by measuring the reference signal corresponding to the second cell and reference signals corresponding to other cells different from the second cell. Therefore, the base station can determine which cell is suitable for dynamic cell switch by receiving the cell switch reporting, thus improving the accuracy of cell switch.

Improved measurement and reporting methods in the case that the terminal device needs to switch cells frequently are provided in the above Embodiments 1 to 4. Compared with the current situation that only high layer measurement and reporting can be supported and the cell switch is lagging behind, methods for enabling stricter measurement and reporting timeline to be satisfied are provided in Embodiments 1 to 4.

### Embodiment 5 (Dynamic Cell Switch, Handover Occasion (HO) Interruption Time)

The method includes: receiving, by a terminal device, indication information including TCI state indication information; the terminal device is not required to perform reception or transmission in a first time period, wherein a start point of the first time period is related to the indication information.

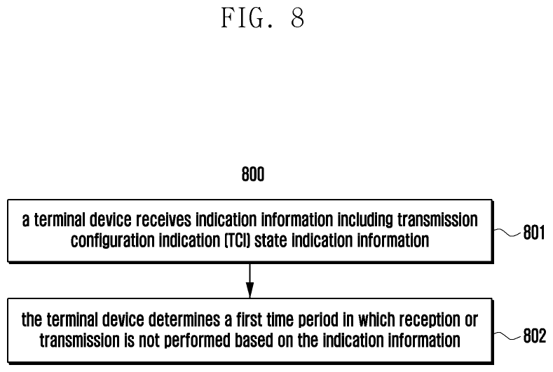

For example, FIG. 8 illustrates a method 800 performed by a UE to determine a handover occasion interruption time during dynamic cell switch according to various embodiments of the present disclosure, which includes: at 801, receiving, by a terminal device, indication information including transmission configuration indication (TCI) state indication information from a base station; at 802, determining, by the terminal device, a first time period in which reception or transmission is not performed based on the indication information.

The determining of the first time period in which reception or transmission is not performed based on the indication information by the terminal device may be understood as that the terminal device is not required to perform reception or transmission in the first time period.

Optionally, the start point of the first time period is related to the indication information.

Optionally, the terminal device is configured with a unified TCI state.

Optionally, the TCI state refers to at least one of a joint TCI state, an uplink TCI state and a downlink TCI state.

Optionally, the indication information is received in a second cell. Optionally, the indication information includes second cell information.

Optionally, the second cell refers to a serving cell or a source cell (for example, a source cell for cell switch). The serving cell may be understood as a cell where the reference signal is located. Optionally, the serving cell may be understood as a cell in which the terminal device obtains the indication information of the reference signal.

Optionally, the indication information corresponds to or indicates first cell(s). Optionally, the indication information includes information of the first cell(s). Optionally, the first cell(s) refers to a cell whose PCI is different from that of the second cell. Optionally, the first cell(s) refers to a candidate cell or a target cell. Optionally, the first cell(s) (or candidate cell/target cell) refers to a cell in which the terminal device receives the configuration information of the cell and which is not the second cell (or an existing serving cell). Optionally, the first cell(s) refers to a cell corresponding to additional PCI configuration information (for example, SSB-MTCAdditionalPCI). Optionally, the target cell may be understood as a target cell for cell switch.

Optionally, a physical downlink control channel (PDCCH) corresponding to the indication information is within the first three symbols of a slot.

Optionally, the start point of the first time period being related to the indication information means that the start point of the first time period is determined by a channel or signal carrying the indication information. Optionally, the start point of the first time period is after the channel or signal carrying the indication information. For example, if the indication information is carried by the PDCCH, the start point of the first time period refers to an end of the third symbol of a slot in which the PDCCH is received.

Optionally, the start point of the first time period being related to the indication information means that the start point of the first time period is determined by a channel or signal carrying a feedback corresponding to the indication information. Optionally, the start point of the first time period is after the channel or signal carrying the feedback corresponding to the indication information. For example, if the indication information is carried by the PDCCH, which triggers automatic repeat request acknowledgement (HARQ-ACK) feedback and the feedback is carried by an uplink channel (PUCCH or PUSCH), the start point of the first time period is after the PUCCH or PUSCH. For another example, if the indication information is indicated by a MAC-CE, the PDSCH carrying the MAC-CE corresponds to HARQ-ACK feedback and the feedback is carried by an uplink channel (PUCCH or PUSCH), then the start point of the first time period is after the PUCCH or PUSCH.

Optionally, an end point of the first time period is a start or end of a slot of the first cell(s). Optionally, the slot (the slot of the first cell(s)) refers to the first slot after X time units from the start point of the first time period. Here, the time units may be at least milliseconds, slots, sub-slots, and symbols. Optionally, X is predefined, indicated by the base station, or related to the terminal device capability. Optionally, X is related to the beam application time. For example, X=max(T_{beam}, Tᵢₙₜₑᵣ); where T_{beam} is the beam application time, and Tᵢₙₜₑᵣ is predefined, indicated by the base station, or related to the terminal device capability. Optionally, when the unit of X is a slot, X corresponds to the slot of the second cell. Optionally, when the unit of X is a slot, X corresponds to the slot of the first cell(s).

Optionally, the end point of the first time period is related to the reference signal transmission of the first cell(s). Optionally, the reference signal transmission is triggered by the indication information. For example, the end point of the first time period is before the reference signal transmission. For another example, the end point of the first time period refers to a start point of the first symbol corresponding to the reference signal. Optionally, the reference signal may be one of: CSI-RS, TRS, and CSI-RS configured with repetition parameters (e.g., repetition). Optionally, the TCI state of the reference signal is the same as the TCI state corresponding to the above TCI state indication.

Optionally, the end point of the first time period is related to the PRACH transmission of the first cell(s). Optionally, the PRACH transmission is triggered by the indication information. For example, the end point of the first time period is before the PRACH transmission. For another example, the end point of the first time period refers to a start point of the first symbol corresponding to the PRACH transmission.

Optionally, a length of the first time period is Y. Optionally, Y is predefined, indicated by the base station, or related to the terminal device capability. Optionally, Y is related to the beam application time. For example, Y=max(T_{beam}, Tᵢₙₜₑᵣ); where T_{beam} is the beam application time, and Tᵢₙₜₑᵣ is predefined, indicated by the base station, or related to the terminal device capability. Optionally, when the unit of Y is a slot, Y corresponds to the slot of the second cell. Optionally, when the unit of Y is a slot, Y corresponds to the slot of the first cell(s).

Optionally, the length of the first time period is related to a subcarrier spacing (SCS) of the second cell. For example, the length of the first time is 5 slots, and the SCS corresponding to the slot is the SCS of the second cell. Optionally, the SCS of the second cell refers to an SCS corresponding to the active/initial/first BWP of the second cell. Optionally, the SCS of the second cell refers to the largest or smallest SCS among all corresponding BWPs.

Optionally, the length of the first time period is related to an SCS of the first cell(s). For example, the length of the first time is 5 slots, and the SCS corresponding to the slot is the SCS of the first cell(s).

Optionally, the SCS of the first cell(s) refers to an SCS corresponding to the active/initial/first BWP of the first cell(s). Optionally, the SCS of the first cell(s) refers to the largest or smallest SCS among all corresponding BWPs. Optionally, if the first cell(s) corresponds to multiple cells, the SCS of the first cell(s) refers to an SCS corresponding to a cell with the smallest ID among the multiple cells corresponding to the first cell(s).

Advantageous effects of Embodiment 5: a method for determining the handover occasion interruption time is provided in Embodiment 5. The method enables the terminal device to accurately determine the start position and/or the end position of the handover occasion interruption time, so as to prevent the terminal device from receiving or transmitting during the period of time, thereby improving the reliability of the device.

### Embodiment 6 (UE Behavior After Dynamic Cell Switch)

The method includes: receiving, by a terminal device, indication information including TCI state indication information; performing, by the terminal device, at least one of the following behaviors in first cell(s) according to the indication information: applying the TCI state indication; triggering reference signal transmission; triggering CSI reporting; triggering PRACH transmission; deactivating or releasing the second cell.

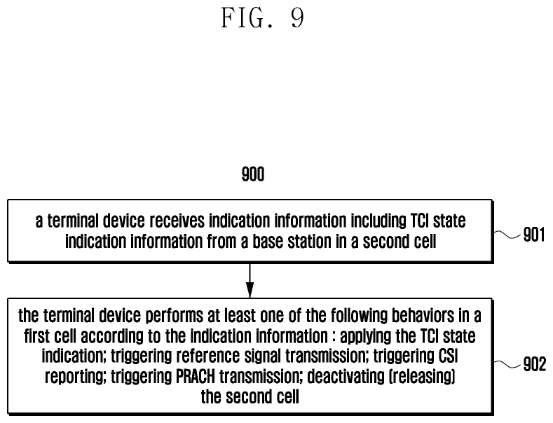

For example, FIG. 9 illustrates a method 900 for determining a behavior of a UE after dynamic cell switch according to various embodiments of the present disclosure, which includes: at 901, receiving, by a terminal device, indication information including TCI state indication information from a base station; at 902, performing, by the terminal device, at least one of the following behaviors in first cell(s) according to the indication information: applying the TCI state indication; triggering reference signal transmission; triggering CSI reporting; triggering PRACH transmission; deactivating (releasing) the second cell.

Optionally, the terminal device is configured with a unified TCI state.

Optionally, the TCI state refers to at least one of a joint TCI state, an uplink TCI state and a downlink TCI state.

Optionally, the indication information is received in the second cell. Optionally, the indication information includes second cell information. Optionally, the second cell refers to a serving cell or a source cell (for example, a source cell for cell switch). The serving cell may be understood as a cell where the reference signal is located. Optionally, the serving cell may be understood as a cell in which the terminal device obtains the indication information of the reference signal.

Optionally, the indication information corresponds to (indicates) the first cell(s). Optionally, the indication information includes information of first cell(s).

Optionally, the first cell(s) refers to a cell whose PCI is different from that of the second cell. Optionally, the first cell(s) refers to a candidate cell or a target cell. Optionally, the first cell(s) (or candidate cell/target cell) refers to a cell in which the terminal device receives the configuration information of the cell and which is not the second cell (or an existing serving cell). Optionally, the first cell(s) refers to a cell corresponding to additional PCI configuration information (for example, SSB-MTCAdditionalPCI). Optionally, the target cell may be understood as a target cell for cell switch.

Optionally, the indication information corresponds to a PDCCH or the indication information is carried by a MAC-CE.

Optionally, the PDCCH corresponding to the indication information is within the first three symbols of a slot.

Optionally, the terminal device triggers the reference signal transmission in the first cell(s) according to the indication information. Optionally, the reference signal is a CSI-RS, for example, a CSI-RS for tracking and a CSI-RS configured with repetitive parameters. Optionally, an offset between a channel or signal corresponding to the indication information and the reference signal is related to an SCS of the first cell(s). For example, an SCS of a slot corresponding to a slot offset between the PDCCH corresponding to the indication information and the reference signal is the SCS of the first cell(s). Optionally, the SCS of the first cell(s) refers to an SCS corresponding to the active/initial/first BWP of the first cell(s). Optionally, the SCS of the first cell(s) refers to an SCS corresponding to the BWP indicated by the indication information of the first cell(s).

Optionally, the terminal device triggers the CSI reporting in the first cell(s) according to the indication information. Optionally, the quantity corresponding to the reporting is L1-RSRP or L1-SINR. Optionally, an offset between a channel or signal corresponding to the indication information and a PUCCH or PUSCH carrying the CSI-RS reporting is related to the SCS of the first cell(s). For example, an SCS of a slot corresponding to a slot offset between the PDCCH corresponding to the indication information and the PUCCH or PUSCH carrying the CSI-RS reporting is the SCS of the first cell(s). Optionally, the SCS of the first cell(s) refers to the SCS corresponding to the active/initial/first BWP of the first cell(s). Optionally, the SCS of the first cell(s) refers to the SCS corresponding to the BWP indicated by the indication information of the first cell(s).

Optionally, the terminal device triggers the PRACH transmission (or triggers a random procedure) in the first cell(s) according to the indication information. Optionally, the PRACH resource corresponding to the PRACH transmission is dedicated. Optionally, the random procedure is CFRA. Optionally, QCL parameters (for example, QCL type D parameters) corresponding to a feedback (for example, RAR) corresponding to the PRACH transmission are determined according to the TCI state information indication.

Optionally, the terminal device deactivates (releases) the second cell according to the indication information. Optionally, the terminal device receives the indication information, and deactivates (releases) the second cell after a cell switch procedure indicated by the indication information is completed. Optionally, the completion of the cell switch procedure indicated by the indication information refers to completion of a random access procedure triggered by the indication information. Optionally, the completion of the cell switch procedure indicated by the indication information refers to reception of the above reference signal triggered by the indication information.

Optionally, the terminal device applies the TCI state indication in the first cell(s) according to the indication information. Optionally, in the first cell(s), a QCL parameter corresponding to a control resource set (CORESET (for example, CORESET #0)) is provided by the TCI state indication. Optionally, in the first cell(s), a QCL parameter corresponding to the PDSCH or PUSCH is provided by the TCI state indication. Optionally, in the first cell(s), a QCL parameter corresponding to the reference signal (for example, CSI-RS, aperiodic CSI-RS, CSI-RS for tracking, aperiodic SRS, SRS) is provided by the TCI state indication. Optionally, in the first cell(s), a QCL parameter corresponding to the PUCCH is provided by the TCI state indication.

Advantageous effects of Embodiment 6: a method for determining the UE behavior after the cell switch is provided in Embodiment 6. The method can provide or trigger subsequent measurement, reporting, beam indication and uplink synchronization (for example, using the PRACH transmission) through the cell switch indication command, so that the terminal device can establish a communication link with the base station after switching to the target cell, thereby avoiding additional signaling overhead and improving the performance of the communication system.

### Embodiment 7 (Beam Failure Recovery (BFR) Initiated Cell Switch)

The method includes: transmitting, by a terminal device, a request to a base station in a second cell, wherein the request corresponds to or includes reference signal information, and the reference signal information is related to first cell(s); receiving, by the terminal device, a response corresponding to the request in the second cell; applying/using, by the terminal device, a QCL parameter corresponding to the reference signal information in the first cell(s).

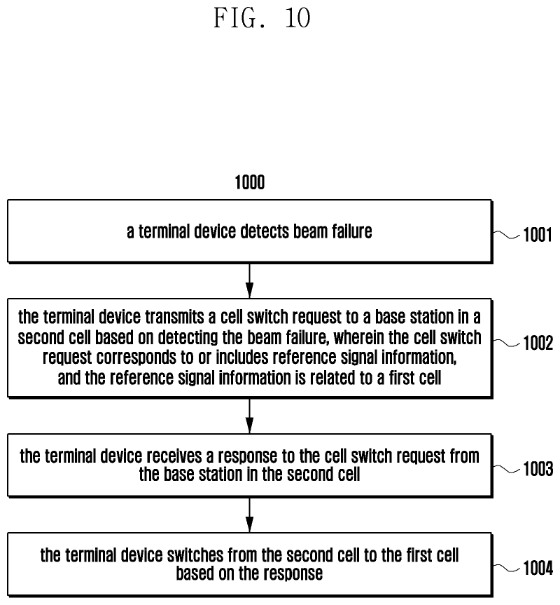

For example, FIG. 10 illustrates a method 1000 of cell switch initiated by a UE based on beam failure recovery according to various embodiments of the present disclosure, which includes: at 1001, detecting, by a terminal device, beam failure; at 1002, transmitting, by the terminal device, a request related to beam failure recovery to a base station in a second cell based on detecting the beam failure, wherein the request corresponds to or includes reference signal information, and the reference signal information is related to first cell(s); at 1003, receiving, by the terminal device, a response to the cell switch request from the base station in the second cell; at 1004, switching, by the terminal device, from the second cell to the first cell(s) based on the response.

Optionally, the terminal device applies/uses the quasi co-location (QCL) parameter corresponding to the reference signal information to transmit a channel and/or a signal in the first cell(s). Optionally, the signal or channel refers to at least one of: a PUSCH, an SRS, a PUCCH.

Optionally, the terminal device applies/uses the quasi co-location (QCL) parameter corresponding to the reference signal information to receive a channel and/or a signal in the first cell(s). Optionally, the signal or channel refers to at least one of: a PDCCH, a CORESET, a PDSCH, an SSB, a CSI-RS.

Optionally, the terminal device applies/uses the quasi co-location (QCL) parameter corresponding to the reference signal information to monitor a channel and/or a signal in the first cell(s). Optionally, the signal or channel refers to at least one of: a PDCCH, a CORESET, a PDSCH, an SSB, a CSI-RS. For example, the terminal device applies/uses the quasi co-location (QCL) corresponding to the reference signal information to monitor the PDCCH in CORESET #0 in the first cell(s).

Optionally, the reference signal information is determined from a reference signal group; reference signals in the reference signal group are used to identify candidate beams for recovery.

Optionally, the reference signal information being related to the first cell(s) means that a relationship between the reference signal and the first cell(s) is predefined or indicated by the base station.

Optionally, the request further corresponds to or includes information of the first cell(s).

Optionally, the second cell refers to a serving cell or a source cell (for example, a source cell for cell switch). The serving cell may be understood as a cell where the reference signal is located. Optionally, the serving cell may be understood as a cell in which the terminal device obtains the indication information of the reference signal.

Optionally, the first cell(s) refers to a cell whose PCI is different from that of the second cell. Optionally, the first cell(s) refers to a candidate cell or a target cell. Optionally, the first cell(s) (or candidate cell/target cell) refers to a cell in which the terminal device receives the configuration information of the cell and which is not the second cell (or an existing serving cell). Optionally, the first cell(s) refers to a cell corresponding to additional PCI configuration information (for example, SSB-MTCAdditionalPCI). Optionally, the target cell may be understood as a target cell for cell switch.

Optionally, the request refers to PRACH transmission. Optionally, the PRACH transmission is used for beam failure recovery. Optionally, a PRACH resource corresponding to the PRACH transmission is used for beam failure recovery. Optionally, the request refers to a MAC-CE, for example, a BFR MAC-CE (MAC-CE for beam failure recovery). Optionally, the MAC-CE is carried by a first PUSCH.

Optionally, the response refers to a PDCCH. Optionally, the PDCCH is scrambled by a cell radio network temporary identifier (C-RNTI). Optionally, a search space set corresponding to the PDCCH is used for beam failure recovery. Optionally, the PDCCH is used to schedule a second PUSCH. Optionally, a HARQ process number corresponding to the second PUSCH is the same as that of the above first PUSCH carrying the MAC-CE. Optionally, an NDI corresponding to the DCI scheduling the first PUSCH is reversed relative to an NDI corresponding to DCI scheduling the second PUSCH.

Optionally, the terminal device applies the QCL parameter corresponding to the reference signal information after a second time period in which the response is received. Optionally, the terminal device applies the QCL parameter corresponding to the reference signal information in the first cell(s) after the second time period in which the response is received.

Optionally, a length of the second time period is Y. Optionally, Y is predefined, indicated by the base station, or related to the terminal device capability. Optionally, Y is related to the beam application time. For example, Y=max(T_{beam}, Tᵢₙₜₑᵣ); where T_{beam} is the beam application time, and Tᵢₙₜₑᵣ is predefined, indicated by the base station, or related to the terminal device capability.

Optionally, the length of the second time period is related to an SCS of the second cell. For example, the length of the first time is 5 slots, and the SCS corresponding to the slot is the SCS of the second cell. Optionally, the SCS of the second cell refers to an SCS corresponding to the active/initial/first BWP of the second cell. Optionally, the SCS of the second cell refers to the largest or smallest SCS among all corresponding BWPs.

Optionally, the length of the second time period is related to an SCS of the first cell(s). For example, the length of the first time is 5 slots, and the SCS corresponding to the slot is the SCS of the first cell(s).

Optionally, the SCS of the first cell(s) refers to an SCS corresponding to the active/initial/first BWP of the first cell(s). Optionally, the SCS of the first cell(s) refers to the largest or smallest SCS among all corresponding BWPs. Optionally, if the first cell(s) corresponds to multiple cells, the SCS of the first cell(s) refers to an SCS corresponding to a cell with the smallest ID among the multiple cells corresponding to the first cell(s).

Advantageous effects of Embodiment 7: a method for determining the cell switch reporting triggered or initiated by BFR and the subsequent UE behavior is provided in Embodiment 7. The method can recovery the link using the cell switch in the scenario of the beam failure, which improves the reliability of the communication system.

Improved mobility indication methods in the case that the terminal device needs to switch cells frequently are provided in the above Embodiments 5 to 7. Compared with the current situation that only high layer measurement and reporting can be supported and the cell switch is lagging behind, methods for enabling mobility to be indicated more quickly are provided in Embodiments 5 to 7.

The present disclosure provides a method for reducing the delay of terminal device mobility measurement and reporting so that the base station can decide whether to perform cell switch faster and better. In addition, the present disclosure also provides a method for cell switch indicating to reduce the time of cell switch, thereby improving the performance of the communication system.

Although the method performed by the base station in the wireless communication system is not shown herein, it should be understood that the present disclosure includes various methods performed by the base station corresponding to the above methods performed by the UE.

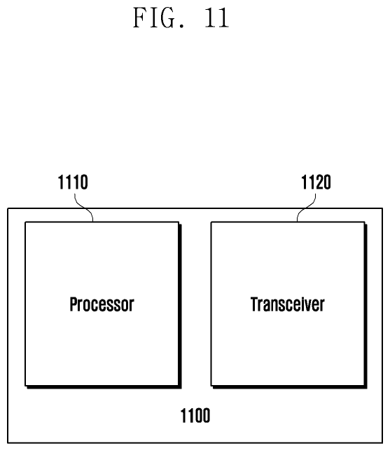

FIG. 11 illustrates a structure 1100 of a UE according to various embodiments of the present disclosure. As shown in FIG. 11, the UE 1100 includes a processor 1110 and a transceiver 1120, wherein the processor 1110 is configured to perform the above various methods disclosed herein and performed by the UE, and the transceiver 1120 is configured to transceive channels or signals.

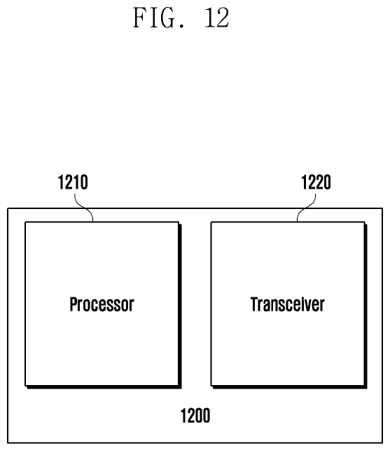

FIG. 12 illustrates a structure 1200 of a base station according to various embodiments of the present disclosure. As shown in FIG. 12, the base station 1200 includes a processor 1210 and a transceiver 1220, wherein the processor 1210 is configured to perform various methods corresponding to the above methods disclosed herein and performed by the UE, and the transceiver 1220 is configured to transceive channels or signals.

According to various aspects of the present disclosure, the described indication information (or configuration information) received by the UE from the base station may be transmitted via radio resource control (RRC), media access control (MAC) resource element (CE) or downlink control information (DCI).

It should be understood that, in the description of various embodiments in the present disclosure, the reference signal (or reference signal resource) being related to the first cell(s) may be understood as that: the QCL reference signal (or QCL source reference signal) corresponding to the reference signal corresponds to the first cell(s) (or the ID of the first cell(s) or the physical cell identifier (PCI) of the first cell(s)). Optionally, the reference signal and the first cell(s) may also be understood as that: the QCL type A reference signal and/or QCL type D reference signal corresponding to the reference signal correspond to the first cell(s). For example, the reference signal is a CSI-RS, and a reference signal (or QCL source reference signal) corresponding to the CSI-RS is an SSB. The SSB corresponds to the first cell(s) (or a PCI of the cell corresponding to the SSB is different from that of the second cell). Optionally, the above SSB is the above QCL type D reference signal of the CSI-RS. Optionally, the above SSB is the above QCL type A reference signal of the CSI-RS.

In addition, in the description of various embodiments in the present disclosure, the reference signal (or reference signal resource) corresponding to the second cell may be understood as that the reference signal (or reference signal resource) is not associated with cells other than the second cell.

It should be understood that, in the description of various embodiments in the present disclosure, the first condition may be understood as a predefined condition.

It should be understood that, the description of “reference signal” in the present disclosure includes both the description of “reference signal” and the description of “reference signal resource”.

In addition, “at least one item/at least one” described in the present disclosure includes any and/or all possible combinations of listed items, and various embodiments and various examples in embodiments described in the present disclosure can be changed and combined in any suitable form, and “/” described in the present disclosure represents “and/or”.

The illustrative logical blocks, modules, and circuits described in the present disclosure may be implemented in a general-purpose processor, a Digital Signal Processor (DSP), an application specific integrated circuit, ASIC), Field Programmable Gate Array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in the present disclosure may be embodied directly in hardware, in a software module executed by a processor, or in a combination of the two. Software modules may reside in RAM memory, flash memory, ROM memory, EPROM memory, EEPROM memory, registers, hard disks, removable disks, or any other form of storage media known in the art. An exemplary storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more exemplary designs, the described functions may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth herein, taken in conjunction with the drawings, describes example configurations, methods and devices, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any invention or the scope of the claimed protection, but as descriptions of specific features of specific embodiments of specific inventions. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the present invention is illustrative of an exemplary process. Based on the design preference, it can be understood that the specific order or hierarchy of steps in the method can be rearranged to realize the functions and effects disclosed in the present invention. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation on the singular is explicitly stated. Therefore, the present disclosure is not limited to the illustrated examples, and any means for performing the functions described herein are included in various aspects of the present disclosure.

Text and drawings are provided as examples only to help readers understand the present disclosure. They are not intended and should not be construed to limit the scope of the present disclosure in any way. Although certain embodiments and examples have been provided, based on the disclosure herein, it is obvious to those skilled in the art that changes can be made to the illustrated embodiments and examples without departing from the scope of the present disclosure.

1. A method performed by a user equipment UE in a wireless communication network, the method comprising:
receiving indication information from a base station, wherein the indication information indicates information of first cell(s) associated with a reference signal; and
determining a timing of the reference signal based on a timing of the first cell(s).

2. The method of claim 1, wherein the information of the first cell(s) associated with the reference signal comprises an identifier of the first cell(s) associated with a quasi co-location QCL reference signal of the reference signal.

3. The method of claim 1, wherein the determining of the timing of the reference signal based on the timing of the first cell(s) comprises one of:
determining the timing of the reference signal based on the timing of the first cell(s) based on an identifier of the first cell(s) associated with a QCL reference signal of the reference signal indicated by the indication information.

4. The method of claim 1, further comprising at least one of:
determining the timing of the reference signal according to a timing of a serving cell based on the indication information indicating that a QCL reference signal of the reference signal does not correspond to a PCI of the first cell(s);
determining the timing of the reference signal according to the timing of the first cell(s) based on the indication information indicating that the timing of the reference signal is not the timing of the serving cell;
determining the timing of the reference signal according to the timing of the serving cell based on the indication information indicating that the timing of the reference signal is the timing of the serving cell.

5. The method of claim 1, wherein the reference signal is used for Layer 1 measurement.

6. The method of claim 1, further comprising:
receiving indication information of a mobility reference signal for Layer 1 measurement and/or Layer 3 measurement from the base station; and
performing the Layer 1 measurement and/or the Layer 3 measurement related to the mobility reference signal according to the indication information.

7. The method of claim 6, wherein the performing of the Layer 1 measurement and/or the Layer 3 measurement related to the mobility reference signal according to the indication information comprises one of:
performing the Layer 1 measurement related to the mobility reference signal based on the indication information of the mobility reference signal for the Layer 1 measurement;
performing the Layer 3 measurement related to the mobility reference signal based on the indication information of the mobility reference signal for the Layer 3 measurement;
performing the Layer 3 measurement and the Layer 1 measurement related to the mobility reference signal based on the indication information of the mobility reference signal for the Layer 3 measurement and the Layer 1 measurement;
performing the Layer 1 measurement or the Layer 3 measurement related to the mobility reference signal in a case that the indication information is not received.

8. The method of claim 6, further comprising:
reporting a UE capability including: a capability to support performing the Layer 1 measurement using the mobility reference signal and/or performing the Layer 3 measurement using the mobility reference signal.

9. The method of claim 1, further comprising:
receiving reporting configuration information from the base station;
receiving indication information from a base station, wherein the indication information indicates information of first cell(s) associated with reference signal(s);
reporting reference signal information and corresponding indicator(s), wherein the indicator indicates mobility related information of the first cell(s),
wherein the indicator(s) indicating the mobility related information of the first cell(s) comprises:
the indicator(s) indicating whether the first cell(s) satisfies a cell switch condition,
wherein the indicator(s) is determined according to at least one of:
a measurement result of a reference signal corresponding to the reference signal information;
a measurement result of a reference signal corresponding to a serving cell;
K measurement results of the reference signal corresponding to the reference signal information, where K is an integer greater than or equal to 1.

10. The method of claim 1, further comprising:
receiving indication information from the base station in a second cell, wherein the indication information includes transmission configuration indication TCI state indication information and information of first cell(s); and
performing at least one of the following behaviors in the first cell(s) according to the indication information:
applying the TCI state indication;
triggering reference signal transmission;
reporting channel state information CSI reporting;
transmitting a physical random access channel PRACH;
releasing a serving cell of the UE.

11. The method of claim 1, further comprising:
receiving at least one reference signal information and information related to first cell(s) corresponding to the reference signal information transmitted by the base station;
transmitting a request corresponding to first reference signal information of the at least one reference signal information to the base station;
receiving a response to the request from the base station;
applying the first reference signal information in the first cell(s) wherein the applying of the configuration information in the first cell(s) comprises: applying the reference signal information after a second time period in which the response is received,
wherein,
a length of the second time period is related to an SCS of a serving cell of the UE; or,
a length of the second time period is related to an SCS of the first cell(s).

12. The method of claim 1, further comprising:
receiving, by the UE, indication information from the base station, wherein the indication information includes transmission configuration indication TCI state indication information; and
not requiring the UE to perform transmission or reception in a first time period, wherein the first time period is related to the indication information.

13. A user equipment UE in a wireless communication system, the UE comprising:
a transceiver; and
a processor configured to:
receive indication information from a base station, wherein the indication information indicates information of first cell(s) associated with a reference signal; and
determine a timing of the reference signal based on a timing of the first cell(s).

14. A method performed by a base station in a wireless communication system, the method comprising:
transmitting indication information, wherein the indication information indicates information of first cell(s) associated with a reference signal; and
transmitting the reference signal.

15. A base station in a communication system, the base station comprising:
a transceiver; and
a processor configured to:
transmit indication information, wherein the indication information indicates information of first cell(s) associated with a reference signal; and
transmit the reference signal.
